(19) United States
(12) Patent Application Publication
(10) Pub. No.: US 2008/0210896 A1
(43) Pub. Date: Sep. 4, 2008

(54) Electromagnetically Controllable Actuator

(75) Inventors: Joachim Bohn, Hundaangen (DE); Holger Kollmann, Mainhausen (DE)

Correspondence Address: CONTINENTAL TEVES, INC., ONE CONTINENTAL DRIVE, AUBURN HILLLS, MI, 48326-1581, US

(73) Assignee: CONTINENTAL TEVES AG & OHG

(21) Appl. No.: 11/667,875

(22) PCT Filed: Nov. 28, 2005
(86) PCT No.: PCT/EP2005/056268

§ 371 Date: Nov. 14, 2007

(30) Foreign Application Priority Data
Nov. 26, 2004 (DE) 10 2004 057 134.1
Nov. 28, 2005 (DE) 10 2005 056 776.2

(51) Int. Cl. F16K 31/02; H01F 7/06; F16K 31/36

(52) U.S. Cl. 251/129.02; 29/606; 137/487.5

(57) ABSTRACT

Disclosed is a method of manufacture or adjustment of an electromagnetically drivable actuator, which is appropriate for controlling the flow of a fluid, such as a hydraulic or pneumatic analog valve or an analogized switch valve (10). The actuator has an electromagnetic arrangement that is drivable by an exciter coil (12) having at least one movable armature (6). The electromagnetic arrangement acts mechanically upon a valve actuating device for opening and closing the actuator. The valve actuating device has a closing element (5), a resetting element (9) for opening or closing the closing element when the exciter coil is not excited, and one valve seat (4) into which the closing element engages. According to the method, the properties of the valve are adjusted by insertion of a spacer element (1). The spacer element (1) allows at least displacing a stop of the resetting element in an axial direction corresponding to the armature movement. Also disclosed is an actuator that allows implementation of the method.

### BACKGROUND OF THE INVENTION

The present invention relates to a method for manufacturing or adjusting an electromagnetically drivable actuator, which is appropriate for controlling the flow of a fluid, such as a hydraulic or pneumatic analog valve or an analogized switch valve (10). The actuator comprises an electromagnetic arrangement that is drivable by an exciter coil (12) including at least one movable armature (6). The electromagnetic arrangement acts mechanically upon a valve actuating device for opening and closing the actuator, with the valve actuating device comprising at least one closing element (5), one resetting element (9) for opening or closing the closing element when the exciter coil is not excited, and one valve seat (4) into which the closing element for opening or closing the actuator engages. The properties of the valve are adjusted by insertion of a spacer element (1) with a defined length a, which allows at least the displacement of a stop of the resetting element in an axial direction corresponding to the armature movement, or in that the spacer element (1) is inserted into a defined position, which brings about a defined distance 1 between the armature abutment surface (17) and the abutment surface (11) of the spacer element. The generic actuator especially concerns an analogized digital control valve (A/D valve) in a brake control system for motor vehicles with at least ABS functions.

It is known in the art to employ electromagnetically controllable analogized valves in ABS control units for motor vehicle brake systems, but also in so-called driving dynamics controllers with additional functions such as ESP, etc., for the purpose of an improved control or for noise reduction.

In up-to-date generations of hydraulic control devices, so-called analogized switch valves are used. An analogized switch valve is a solenoid valve actuated mostly by way of a PWM current control, which is per se designed to completely open or closed, however, is so operated by purposeful current adjustment that it has analog control properties.

EP 0 813 481 B1 (P 7565) discloses a method of detecting the switch point of an analog operable switch valve, in particular for determining the pressure conditions from the current variation of the valve drive current.

In principle, it is consequently possible to adjust the pressure gradient or flow G of a corresponding analogized switch valve in dependence on the differential pressure by way of variation of the current through the magnet coil of the valve. The volume flow Q in the range of the control must be adjusted with a very high rate of precision. The essential coefficients of influence are the differential pressure Δp, the current I through the magnet coil of the valve and various valve parameters, which are predetermined mechanically and generally inhere tolerances. Although it is feasible to use characteristic fields in order to define the desired flow, it is not easily possible to store the dependency of the above quantities in a once defined characteristic field. This results from the fact that tolerances of the valve components being due to manufacture have a relatively great influence on the needed drive current. It is therefore necessary to determine a characteristic field for each individual valve during manufacture of the valves and to store it in a memory of the electronics of the control unit. To establish the characteristic curves for individual valves, however, a complicated measuring method would be necessary with defined pressurizations of the control units at the supplier's site or at the end of the assembly line at the plant of the motor vehicle manufacturer. The characteristic fields being determinable this way could then be used to adjust the desired pressure gradient, as has been described e.g. in WO 01/98124 A1 (P 9896).

In the former non-published application PCT/EP 2004/051635 (P10989) of 28 Jul. 2004, an alternative method for the adjustment of a valve has been described, wherein the valve seat can be displaced to achieve improved valve control. There is still the object of improving the properties of the mentioned actuators in such a way that they can be employed better for the intended analog control.

### SUMMARY OF THE INVENTION

According to the invention, this object is achieved by a method for manufacturing or adjusting an electromagnetically drivable actuator, which is appropriate for controlling the flow of a fluid, such as a hydraulic or pneumatic analog valve or an analogized switch valve (10). The actuator comprises an electromagnetic arrangement that is drivable by an exciter coil (12) including at least one movable armature (6). The electromagnetic arrangement acts mechanically upon a valve actuating device for opening and closing the actuator, with the valve actuating device comprising at least one closing element (5), one resetting element (9) for opening or closing the closing element when the exciter coil is not excited, and one valve seat (4) into which the closing element for opening or closing the actuator engages. The properties of the valve are adjusted by insertion of a spacer element (1) with a defined length a, which allows at least the displacement of a stop of the resetting element in an axial direction corresponding to the armature movement, or in that the spacer element (1) is inserted into a defined position, which brings about a defined distance 1 between the armature abutment surface (17) and the abutment surface (11) of the spacer element.

It has been found that the above-mentioned causes for the remaining deviations of the characteristic curves, or their gradients in particular, predominantly originate from the tolerances of the mechanics, e.g. the varying spring force, and of the magnetic field circuit (e.g. magnetic resistances of the air slots, etc.). It has been found in addition that a defined air slot range (for example, distance d, slot between armature and housing 7) should be maintained for a uniform behavior of the actuators. Therefore, there is a need for valves, which in series production exhibit a deviation in electromagnetic and mechanical properties as insignificant as possible. Especially a uniform current characteristic curve for the actuator can be achieved by maintaining a predetermined air slot range and, in particular, by simultaneous adjustment of the spring force in the presence of a defined magnetic flux. Consequently, the invention preferably relates to a method that allows adjusting a particularly suitable air slot.

Admittedly, there are reasons in the design engineering of valves demanding the air slot d to be as large as possible.

However, this procedure is disadvantageous in the electric actuation and leads to reduced magnetic force depending on the current. Therefore, there is an optimal range or value for the air slot d, which can be found easily by routine tests.

The method of the invention allows adapting the characteristics (force/travel characteristic curve) of the resetting element by means of a spacer element inserted into the actuator in such a fashion that a defined air slot range is maintained in the operating point of the valve. In contrast to adjusting the residual air slot by displacement of the valve seat, this has proved more favorable in practice because the valve control can be performed with an improved quality. Consequently, the installation space for the resetting element and, hence, the preload of the resetting element is adjusted in a targeted manner by the insertion of the spacer element.

According to a preferred embodiment of the method, at least one electromagnetic property of the actuator is measured, and the measured electromagnetic property itself or a quantity derived therefrom is used as a command variable for determining the insertion depth 1 of the spacer element with respect to the armature abutment surface 17 (FIG. 2) in the direction of movement of the resetting element. This allows adjusting the spring preload of the resetting element in the working point to a defined value.

The term ‘actuators’ relates to valves and slides for the adjustment of fluid flow. In a most preferable manner, the actuators used are valves. The fluid preferred is air or also any appropriate hydraulic fluid, which is in particular a customary brake fluid in the application with a brake. The actuator comprises an electromechanical arrangement and a valve actuating device with a closing element. The electromechanical arrangement favorably comprises a closing element, which is connected mechanically to an armature or is in operative engagement therewith, respectively. Favorably, the closing element is a tappet. The closing element is moved back by a resetting element in the absence of current flowing through the exciter coil. The resetting element is preferably a resetting spring.

Favorably, the actuator has a completely opened and a completely closed position. Depending on the type of actuator, normally open (NO-V) or normally closed (NC-V), the actuator adopts one of these positions, in response to the action of a resetting element. An appropriate resetting element is preferred to be a spring, which has a force/travel characteristic curve that is predefined to the greatest extent possible.

The method of the invention is advantageously implemented to manufacture valves for an electrohydraulic device for the brake control of motor vehicles, such as an ABS/ESP brake control unit.

As has been mentioned hereinabove, it has been found that the causes for undesirable deviations of the actuator characteristic curves, or their gradients in particular, predominantly originate from tolerances of the mechanics, e.g. the varying spring force F_{spring}, and of the magnetic field circuit (e.g. magnetic resistances of the air slots, etc.) of the actuator.

The measured electromagnetic property used for the adjustment favorably is one or more properties of the actuator of the group:
magnetic resistance R_{M} of the electromechanical arrangement,
inductance L of the electromechanical arrangement,
the electrically measured magnetic force F_{magn} acting on the valve actuating device, or the related magnetic flux,
the holding current I_{hold} necessary for opening or closing, or
the opening current Iₒₚₑₙ necessary for opening or closing.

Alternatively or in addition, the spring preload can be adjusted in particular by determining the distance 1 or the insertion depth of the spring abutment. In lieu of the measurement of the insertion depth, measuring the spring force, e.g. by way of a force sensor, is especially suitable.

According to the method of the invention, a controller preferably adjusts the opening current, the holding current, the magnetic resistance, or the inductance. This can be done, for example, when the actuator is completely closed or also in conditions of the actuator being actuated in a defined manner. Particularly in the case of a valve, the spring preload in the mechanical arrangement is reduced to such an extent by displacing the spacer element, until the magnetic flux corresponds to a desired value.

It is another object of the invention to obtain in a production process a minimum possible deviation or a uniform performance in the electric characteristic curves with regard to the pressure quantity being adjusted. Preferably, this is a characteristic curve, which defines the relationship between opening current and differential pressure. Therefore, the actuator is exposed to an exactly defined predetermined differential pressure and/or an exactly defined predetermined flow during the manufacture or adjustment according to another preferred embodiment of the method.

According to a preferred embodiment of the method, the magnetic total resistance Rₘ of the magnetic circuit in the electromagnetic arrangement is measured. It applies in general that instead of the magnetic resistance, it is also possible to use the inductance L of the corresponding magnetic circuit, with respect to the winding number N of the coil, as an equivalent physical quantity in a corresponding manner in order to implement the method of the invention.

At least one additional measuring element, especially at least one measuring coil, is provided in the magnetic circuit and allows measuring the inductance, the magnetic flux, or the magnetic resistance, respectively. Apart from a coil, it is principally possible to use other per se known magnetic-field-responsive sensors, such as Hall sensors, MR sensors, etc. as a measuring element, provided they are appropriate to sense the effective magnetic flux. However, using a coil appears especially suitable because it allows low-cost manufacture.

The measuring coil described hereinabove can be electrically independent of the exciter coil. According to a preferred embodiment, it is, however, also possible to connect the measuring coil electrically in series with the exciter coil. This is advantageous because only three actuating conduits are required.

The flow G of the actuator or valve, apart from the differential pressure and the geometric flow properties, is principally determined by the force, which acts on the tappet of the respective actuator (tappet force). The magnetic force F_{magn}, the pressure-responsive force F_{hydr} generated by the fluid (e.g. pneumatic or hydraulic force), and the force F_{spring} exerted by the resetting element simultaneously act on the tappet of the valve. These jointly acting forces counterbalance each other in equilibrium of forces (tappet stands still). In this condition, the so-called holding current I_{hold} is just flowing in the case of a magnetic force generated by way of an exciter coil.

One special feature of the preferred method of the invention, among others, resides in that, preferably, the magnetic flux is measured, and control is performed according thereto in particular. This is suitable because the magnetic force, which corresponds to the spring force in balance, is directly dependent on the magnetic flux.

Besides, a preferred embodiment of the invention suggests employing a hardly magnetizable metal, such as austenitic steel in particular, at least as the material for the spacer element, and the said material in principle can be appropriate for the manufacture of other parts of the actuator as well. The advantage of a reduction of the required switching energy is thereby achieved. It is thus especially possible to avoid or reduce magnetic short-circuits in the area of the tappet guide and in the housing.

The above explanations, which apply only to a normally open valve or actuator, shall apply in analog way also to a normally closed valve or actuator, respectively.

Further preferred embodiments can be taken from the following description of embodiments by way of Figures.

### BRIEF DESCRIPTION OF THE DRAWINGS

In the accompanying drawings:

FIG. 1 is a cross-sectional view of an analog valve according to the older PCT patent application described; and

FIG. 2 is a cross-sectional view of an analog valve according to the invention.

### DETAILED DESCRIPTION OF THE DRAWINGS

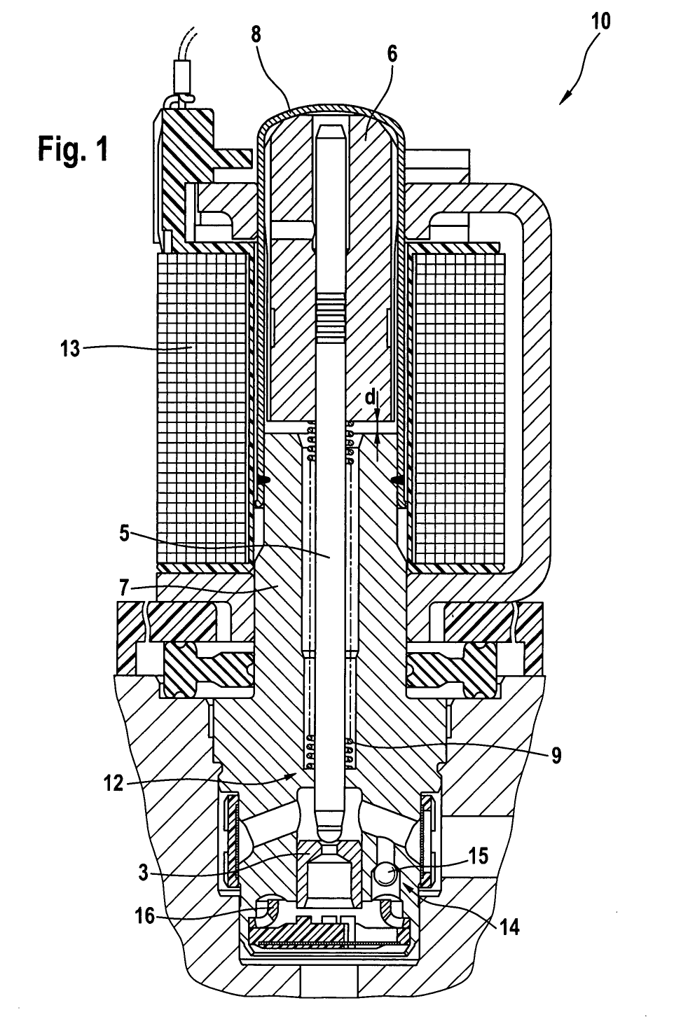

FIG. 1 shows a solenoid valve 10 for an electrohydraulic brake system in a motor vehicle with ABS/ESP functions. Armature 6, housing 7, sleeve 8, and coil 13 are component parts of the electromagnetic arrangement, which acts mechanically on the actual valve. More specifically, the magnetic field of valve coil 13 moves armature 6, with the result that the latter acts mechanically on tappet 5. Tappet 5 closes the opening in valve seat 3. In the example of a normally open valve (NO valve), resetting spring 9 (this spring is not drawn continuously in the Figures) pushes tappet 5 to assume the open position in the absence of a magnetic field. Armature 6 of the illustrated valve approaches housing 7 when the valve is closing, yet will not touch it. The remaining space between armature and housing is referred to as residual air slot d. Above the area of the valve seat, there is a stop 12 for spring 9, which is molecularly interfaced with housing 7. Reference numeral 14 in the bottom part refers to the non-return valve arranged in the housing.

Ball 15, which is arranged inside non-return valve 14, is retained by ring 16 in the envisaged position.

Likewise the non-inventive solenoid valve in FIG. 1 can be adjusted mechanically by displacement of the valve seat 3 already in a production site with respect to a uniform performance of the opening current. As this occurs, for example, an automaton is used to examine the magnetic resistance in the closed valve position or the opening current.

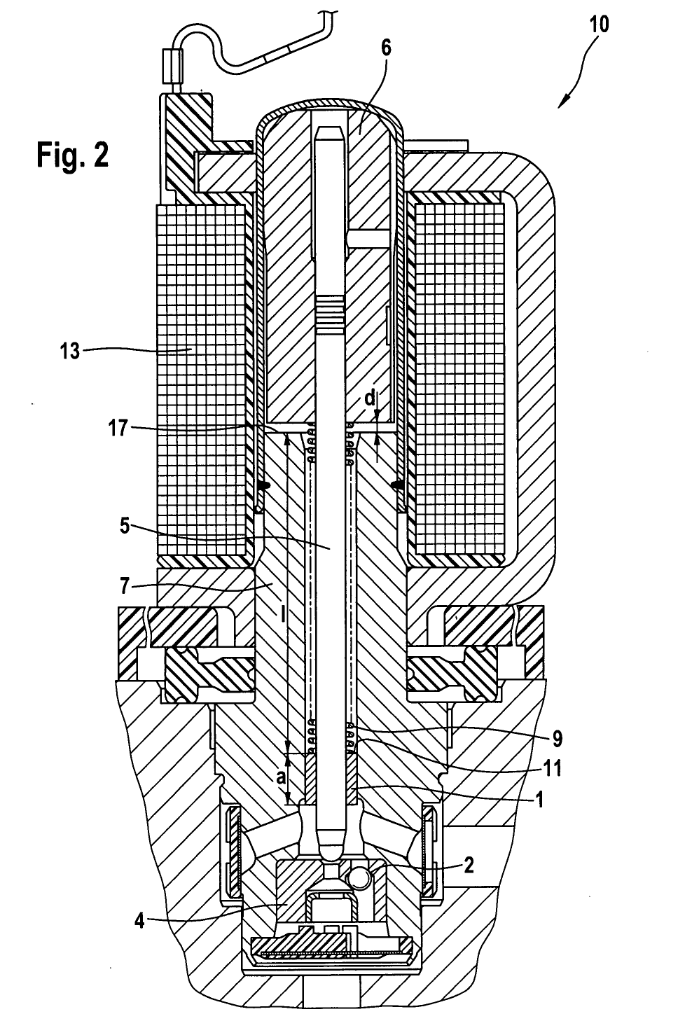

FIG. 2 shows a solenoid valve 10, in which the stop 11 of the resetting spring 9 facing the valve seat with a spacer 1 is displaced in the direction of the armature in order to adjust the spring force (spring 9 is not drawn continuously in the Figures for the sake of clarity in the drawings). This renders it possible in a likewise favorable manner to maintain a predetermined area for the air slot d in the series production of the valves, with the magnetic flux being the same.

To adjust the valve, a mounting device is moved axially into the housing instead of the non-return valve plate 4 during the assembly by means of an automaton of manufacture. The mounting device provides a stop for the valve tappet in an axial direction and, in addition, renders it possible to displace the stop sleeve 4. Now the preassembled armature/tappet unit is inserted into the housing, the residual air slot is adjusted and completed by calking. The valve is operated then. As this occurs, the current signal is evaluated electrically, and a quantity is produced therefrom, which is used as an indicator of the insertion of the stop sleeve. The current evaluation is performed either by integrating measurement of the induced voltage or, in a particularly simple way, by measuring the coil current after disabling of the current control. In principle, the described method of adjustment can also be executed several times in order to achieve a particularly high rate of precision. The method described above can be performed especially with additional pressurization of the valve, with the result that advantages in the signal quality are achieved.

1-8. (canceled)

9. A method for manufacturing an electromagnetically drivable actuator, which is appropriate for controlling the flow of a fluid, such as a hydraulic or pneumatic analog valve or an analogized switch valve (10), with the actuator comprising an electromagnetic arrangement that is drivable by an exciter coil (12) that includes at least one movable armature (6), and with the electromagnetic arrangement acting mechanically upon a valve actuating device for opening and closing the actuator, with the valve actuating device comprising at least one closing element (5), one resetting element (9) for opening or closing the closing element when the exciter coil is not excited, and one valve seat (4) into which the closing element for opening or closing the actuator engages, the method comprising:
adjusting properties of a valve are by inserting a spacer element (1) with a defined length a, which allows at least the displacement of a stop of the resetting element in an axial direction corresponding to the armature movement, or in that the spacer element (1) is inserted into a defined position, which brings about a defined distance I between the armature abutment surface (17) and the abutment surface (11) of the spacer element.

10. A method according to claim 9, wherein at least one electromagnetic property of the actuator is measured and the measured electromagnetic property or a quantity derived therefrom is used as an actual value for controlling a setting variable, and this setting variable is used directly for the manufacture or adjustment of the actuator.

11. A method according to claim 10, the electromagnetic property is one or more properties of the group:
magnetic resistance R_{M} of the electromechanical arrangement, inductance L of the electromechanical arrangement, an electrically measured magnetic force F_{magn} acting on the valve actuating device, a holding current I_{hold} necessary for opening or closing, or an opening current Iₒₚₑₙ necessary for opening or closing of the actuator.

12. A method according to claim 11, wherein the control adjusts the electromagnetic property, which is the opening current, the holding current, the magnetic resistance, or the inductance in particular, when the actuator is completely closed.

13. A method according to claim 10, wherein an adjustment of the actuator is executed by axial displacement of the spacer element (4) and a position is achieved by measuring the distance I between the armature abutment surface (17) and the abutment surface (11) of the spacer element, or by measuring the spring force.

14. A method according to claim 10, wherein for a valve series in consideration of the electromagnetic property, a particularly appropriate area for the size of the air slot d is maintained by displacement of the spacer element.

15. A method according to claim 10, wherein the adjustment is a mechanical adjustment being performed during the manufacturing process of the valve.

16. An actuator (10) for controlling a flow of a fluid, such as a hydraulic or pneumatic analog valve or an analogized switch valve, which is
electromagnetically drivable and comprises an electromagnetic arrangement that is drivable by means of an exciter coil (12) includes at least one movable armature (6), and with the electromagnetic arrangement acting mechanically upon a valve actuating device for opening and closing the actuator, with the valve actuating device comprising at least one closing element (5), one resetting element (9) for opening or closing the closing element when the exciter coil is not excited, and one valve seat (4) into which the closing element for opening or closing the actuator engages, the actuator comprising:
a spacer element (1) with a defined length a in an area of the resetting element and forming a stop for the resetting element in an axial direction of the armature movement, with the resetting element being arranged especially directly above the valve seat, or that it includes a spacer element (1) in the area of the resetting element having a defined distance I between the abutment surface (11) of the spacer element and the armature abutment surface (17).
